(19) United States
(12) Patent Application Publication
(10) Pub. No.: US 2006/0037908 A1
(43) Pub. Date: Feb. 23, 2006

(54) Reverse flow fuel filter

(76) Inventor: John Parkins JR., Bolton, CT (US)

Correspondence Address: ALIX YALE & RISTAS LLP, 750 MAIN STREET, SUITE 1400, HARTFORD, CT, 06103, US

(21) Appl. No.: 11/207,502

(22) Filed: Aug. 19, 2005

Related U.S. Application Data
(60) Provisional application No. 60/603,353, filed on Aug. 20, 2004.

(51) Int. Cl. B01D 35/28

(52) U.S. Cl. 210/443; 210/450; 210/493.1; 210/497.01; 210/440

(57) ABSTRACT

A filter cartridge according to aspects of the present invention positions the outside diameter of the filter element adjacent the inside of the filter cartridge housing. The larger outside diameter of the filter element expands the surface area of filter medium presented to fuel entering the filter cartridge. Positioning the outside diameter of the filter element near the inside surface of the cartridge housing promotes an axial fuel flow pattern across the outside surface of the filter media. This flow pattern is believed to sweep water from the surface of the filter media toward the sump of the cartridge. The flow pattern causes water droplets that coalesce on the outside of the filter media to combine into larger droplets, which then fall into the sump of the cartridge.

### CROSS REFERENCE TO RELATED APPLICATIONS

This application claims the benefit of U.S. Provisional Application 60/603,353, filed Aug. 20, 2004.

### BACKGROUND OF THE INVENTION

1. Field of the Invention

The present invention generally relates to enhancements in devices for filtering and separating liquids. More particularly, the present invention relates to fuel filters for removing foreign particles and separating water from fuel of a fuel supply system associated with an internal combustion engine.

2. Description of the Related Art

Diesel fuel supplies frequently contain significant quantities of abrasive particles and/or water which present the potential for permanent damage to the components of the fuel delivery system of an internal combustion engine. Consequently, an effective fuel filter assembly is a practical necessity and is conventionally incorporated into the fuel supply system of an internal combustion engine. Fuel filter assemblies typically employ a disposable filter cartridge which is replaced at pre-established intervals of filter usage. Such filter cartridges typically perform the dual function of removing particulate material and separating water from the fuel.

The fuel filter assemblies to which the present invention relates include a base which removably receives the replaceable filter cartridge. The base includes a header to provide fuel communication with a filter element inside the cartridge. The header includes a fuel inlet delivering fuel from a fuel tank and a fuel outlet communicating with the fuel delivery system of the internal combustion engine.

Recently developed fuel delivery systems recirculate a significant quantity of fuel and thus require the fuel filter assembly to have a significantly increased flow capacity. For example, a typical prior art fuel assembly may be required to handle eight gallons of fuel per hour while a more modern filter assembly for an equivalent engine may be required to treat 40 gallons of fuel per hour or more. Spatial and cost requirements placed on fuel filter assemblies continue to be significant.

There is a need in the art for fuel filter assemblies which combine high flow capacity with compact size and low cost.

### SUMMARY OF THE INVENTION

A filter cartridge according to aspects of the present invention positions the outside diameter of the filter element adjacent the inside of the filter cartridge housing. The larger outside diameter of the filter element expands the surface area of filter medium presented to fuel entering the filter cartridge. Positioning the outside diameter of the filter element near the inside surface of the cartridge housing promotes an axial fuel flow pattern across the outside surface of the filter media. This flow pattern is believed to sweep water from the surface of the filter media toward the sump of the cartridge. The flow pattern causes water droplets that coalesce on the outside of the filter media to combine into larger droplets, which then fall into the sump of the cartridge.

In the disclosed embodiments, the filter element is an annular, generally cylindrical configuration of chemically treated filter paper in a pleated or folded configuration. The axial ends of the filter media are secured to upper and lower end caps by an appropriate sealing adhesive. The upper end cap is provided with an upstanding lip having a height approximately equal to the sidewall of the upper housing section. This lip places the radially extending plate of the upper end cap below the roll seam joining the two housing sections. The upper end cap is provided with spacers or ribs projecting upwardly and outwardly to center the cap inside the housing and to maintain fluid flow passages radially and axially between the end cap and the housing. A plurality of openings in the upstanding lip of the end cap permit fluid flow radially away from the axial inlet conduit and into fluid flow passages defined between the upper end cap and the cartridge housing.

When the lower section of the cartridge housing is filled with fuel, pressure forces fuel through the filter media radially toward the center of the filter cartridge. The treated filter media rejects water entrained in the fuel, causing the water to coalesce on the outside surface of the filter media. Filtered fuel flows from the center of the cartridge axially out the outlet conduit to the fuel delivery system of the internal combustion engine.

The surface area of the filter element may also be expanded by increasing the radial pleat depth of the filter media as well as optimizing the number of pleats per inch at the outside and inside diameters of the filter element. Increasing the pleat density beyond a certain number of pleats per inch actually reduces the efficiency of a filter cartridge by restricting fuel flow through the media. The expanded surface area of the filter element permits fuel to move through the media relatively slowly, promoting efficient water separation.

### BRIEF DESCRIPTION OF THE DRAWINGS

FIG. 1 is a sectional view through a filter base and first embodiment of a filter cartridge according to aspects of the present invention; and

FIG. 2 is an alternative base and received filter cartridge according to aspects of the present invention.

### DETAILED DESCRIPTION OF THE PREFERRED EMBODIMENT

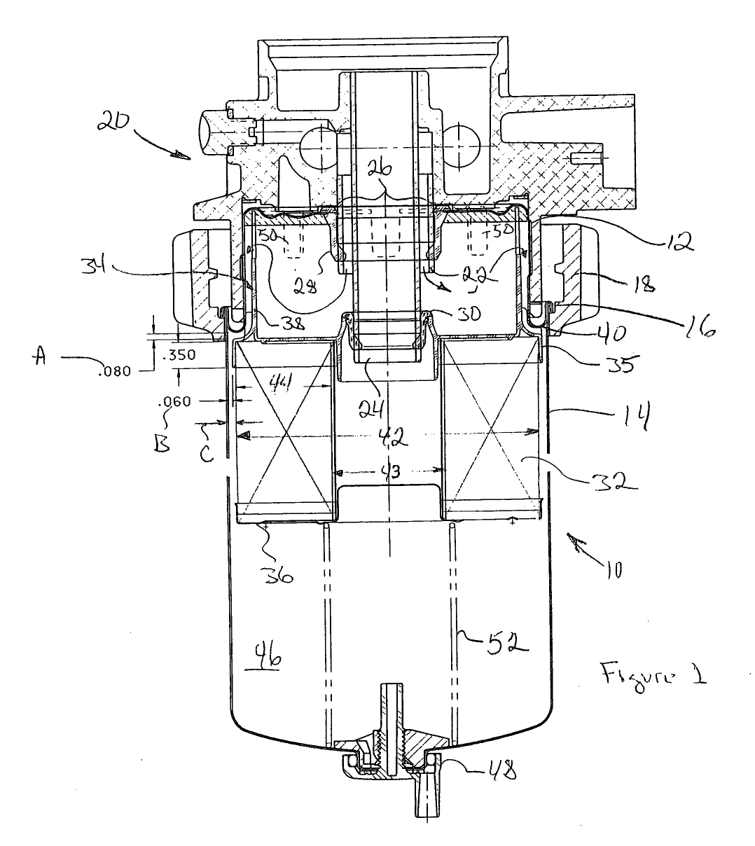

FIG. 1 illustrates first embodiment of a filter cartridge 10 according to aspects of the present invention. The cartridge housing is of conventional configuration having upper and lower housing sections 12, 14 joined at a peripheral roll seam 16. The roll seam 16 provides a radially projecting shoulder that is engaged by a collar 18 to retain the cartridge 10 to a base 20. The housing upper section 12 is received in a receptacle defined by the base 20. Coaxial inlet and outlet conduits 22, 24 penetrate an axial opening 26 in the cartridge housing to be sealingly engaged by grommets 28, 30. A pleated filter element 32 is suspended within the cartridge between upper and lower end caps 34, 36. An axially projecting lip 38 of the upper end cap 34 is axially extended to position the upper end of the filter element 32 below the roll seam 16 and its associated unshaped bend 40. This position places the filter element 32 in the largest diameter section of the filter cartridge housing and allows radial expansion of both the outside diameter 42 as well as the pleat depth 44 of the filter element 32. These expanded dimensions increase the surface area of filter media exposed to fuel flowing through the filter cartridge 10. The filter media is a chemically treated fibrous “paper” material which permits fuel to pass through while rejecting water. Rejected water coalesces on the outside surface of the filter media in the form of small droplets, which cling to the filter media. When the small droplets combine to form droplets large enough, the water falls to the sump 46 formed at the bottom of the housing lower section 14. A drain cock 48 is provided at the bottom of the housing for draining accumulated water.

Another means of increasing the surface area of the filter media exposed to fuel flowing through the cartridge is to increase the number of pleats per inch in the folded filter element. However, if the pleats of the filter media are packed too tightly, the filter cartridge does not benefit from the increased surface area. Thus, a pleat density in the range of 8-12 pleats per inch at the outside diameter 42 of the filter element 32 is preferred. A pleat density at the outside diameter 42 of approximately 10 pleats per inch is most preferred. At the inside diameter 43 a pleat density of between 18 and 23 pleats per inch is preferred with a pleat density of approximately 20 pleats per inch being most preferred.

An aspect of the present invention relates to the fuel flow path around the periphery of the upper end cap 34, between the upper end cap and the inside surface of the cartridge housing. In the illustrated embodiment, an annular space is defined between an upright lip 38 on the upper end cap 34 and the inside surface of the upper section 12 of the cartridge housing. An annular spacing A between the inside surface of the cartridge housing upper section 12 and the upper end cap 34 between 0.050 and 0.30 inches is preferred, with an annular space of approximately 0.080 inches being most preferred. A slightly smaller annular space B between the radial periphery of the upper end cap 34 defined by a downwardly projecting skirt and the inside surface of the housing lower section is preferably between 0.050 and 0.150 inches with an annular space radial dimension of 0.060 being most preferred. The radial spacing C between the outside diameter 42 of the filter element 32 and the inside surface of the housing is preferably between 0.070 and 0.20, with a radial spacing of approximately 0.1 inches being most preferred.

It is believed that this flow path configuration encourages a vigorous flow of fuel over the surface of the filter media in a direction that is substantially perpendicular to the direction of fuel migration through the filter media. In the disclosed embodiments, the primary direction of fuel flow as it enters the lower section of the filter cartridge is toward the sump 46 defined by the housing. Fuel is simultaneously moving through the filter media radially toward the center of the cartridge housing. Relatively speaking, fuel entering the lower section 14 of the cartridge housing is moving faster across the surface of the filter media than fuel migrating through the filter media. The expanded surface area exposed to the fuel permits a relatively slow migration through the media, which is believed to promote efficient collection of water on the outside surface of the filter media. It is further believed that the perpendicular movement of fuel over the filter media surface creates a sweeping action urging small droplets of water to combine into larger droplets which are in turn moved toward the sump by the movement of fuel at the periphery of the housing. Thus, the increased surface area combines with the fuel flow pattern in the cartridge in an unexpected and synergistic manner to significantly increase the water separation efficiency of a filter cartridge without any increase in the overall size of the cartridge. This increased water separation efficiency is of particular significance in modern fuel systems with their increased fuel flow requirements.

The upstanding lip 28 on the upper end cap 34 defines a plurality of angularly spaced fuel flow apertures 50. These apertures 50 open into the annular fuel flow path defined between the upper end cap 34 and the cartridge housing 12, 14. The upper edge of the upstanding lip 28 is seated in an adhesive layer, adhering the upper end cap 34 to the upper housing section 12. The filter element 32 and upper and lower end caps 34, 36 are suspended within the cartridge by this means. In view of the added filter media and its additional weight, the present invention contemplates the necessity of a spring 52 or other support seated in the bottom of the filter cartridge urging the filter element toward the housing upper section 12. This added support may be necessary to resist the tendency for gravity and vibration to pull the filter element away from the housing upper section.

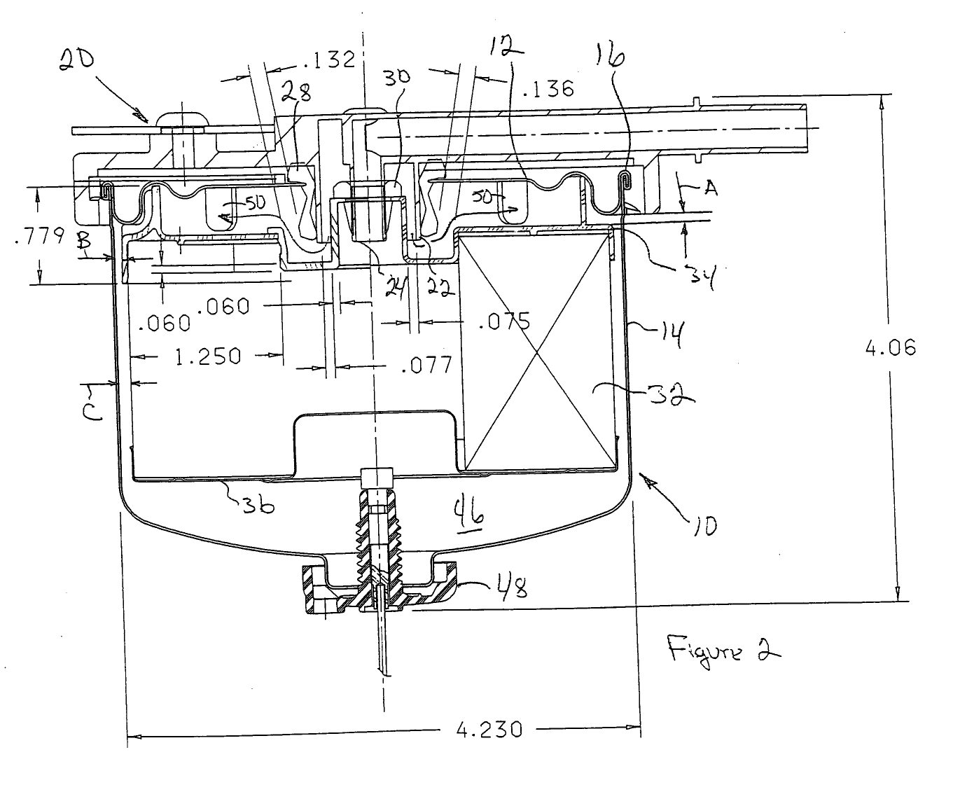

FIG. 2 illustrates an alternative embodiment of a filter cartridge according to aspects of the present invention. The fuel flow path at the periphery of the upper end cap 34 and the position of the filter media relative to the inside surface of the cartridge housing are substantially the same as equivalent features of the cartridge illustrated in FIG. 1. The fuel flow path, expanded outside diameter of the filter media, increased pleat depth of the filter media and the positioning of the outside diameter of the filter element close to the inside surface of the cartridge housing results in unexpectedly enhanced water removal capability in the disclosed filter cartridges. Other differences between the illustrated filter cartridges and their assemblies are related to the particular application for which the cartridges are intended.

In the absence of an expanded filter element surface area, increased fuel flow through the cartridge would produce a rate of fuel flow through the media that exceeds the media water coalescing capability. Conversely, expanded filter media surface area in the absence of the particular fuel flow pattern established by the inventive upper end cap does not produce dramatically improved water separation efficiency. The combination of the particular flow pattern of fuel through the cartridge with an expanded filter media surface area synergistically interact to dramatically improve the water separation capacity of the inventive filter cartridge. The water separation capacity of the inventive filter cartridge is greater than what would be expected from the increased surface area of the filter media alone.

While preferred embodiments of the foregoing invention have been set forth for purposes of illustration, the foregoing descriptions should not be deemed a limitation of the invention herein. Accordingly, various modifications, adaptations and alternatives may occur to one skilled in the art without departing from the spirit and the scope of the present invention.

1. A filter cartridge for filtering fuel passing therethrough, for use with a header of the type having a first port, a second port, a central first conduit defining a first axial fuel passage communicable with the first port, a second conduit surrounding and cooperating with the first conduit to define a second axial fuel passage therebetween, the second axial fuel passage communicating with said second port, said filter cartridge comprising:
a housing defining a substantially cylindrical space having an inside diameter, said housing having a first end defining an axial opening to receive said first and second conduits;
a first end cap defining a second axial opening surrounded by a seal which sealingly engages an exterior surface of the first conduit when said cartridge is mounted to the base, said first end cap comprising a plate radially extending from said second axial opening to a first outside diameter, said end cap including angularly spaced ribs configured to maintain a fluid flow area between the housing and said plate; and
an annular filter element having a second outside diameter and axially spaced first and second ends, said first end secured to said plate to define an annular flow passage between said second outside diameter and said housing second section,
wherein said fluid flow area has a radial dimension of between 0.050 and 0.30 inches and said annular flow passage has a radial dimension of between 0.050 and 0.150 inches.

2. The filter cartridge of claim 1, wherein said fluid flow area has a radial dimension of between 0.060 and 0.120.

3. The filter cartridge of claim 1, wherein said annular flow passage has a radial dimension of between 0.060 and 0.120 inches.

4. The filter cartridge of claim 1, wherein said first end cap comprises an annular lip axially projecting from said plate toward said housing first end, said lip defining a plurality of radial fluid flow passages, and an annular skirt projecting from a periphery of said plate axially away from said housing first end to surround the first end of said filter element.

5. The filter cartridge of claim 1, wherein said first end cap is configured to position said filter element axially below a U-shaped bend at a roll seam connecting first and second housing sections.

6. The filter cartridge of claim 1, wherein said filter element is a folded paper element having a pleat density at said second outside diameter of between 8 and 11 pleats per inch.

7. The filter cartridge of claim 1, wherein said filter element has an inside diameter at least approximately 1 inch smaller than said second outside diameter.

8. The filter cartridge of claim 6, wherein said filter element is a folded paper element comprising a series of pleats, each said pleat extending between said second outside diameter and an inside diameter.

9. The filter cartridge of claim 8, wherein said filter element has a pleat density at said inside diameter of between 15 and 21 pleats per inch.

10. The filter cartridge of claim 1, wherein said annular flow passage has a radial dimension of at least approximately 0.060″ (sixty thousandths of an inch).

11. A filter cartridge for use with a base having a central first conduit defining a first fluid passage communicating with an outlet port and a second conduit defining a second fluid passage communicating with an inlet port, said filter cartridge comprising:
a housing upper section having a first end defining a first axial opening, a substantially cylindrical first side wall having a first inside diameter, said first side wall extending from the first end to a second end and including a radially outward U-shaped bend; and
a housing lower section having a substantially cylindrical second side wall at a second inside diameter greater than said first inside diameter, said second side wall having a first end joined to said upper section second end at a seam to define an interior space;
a substantially cylindrical filter element extending between first and second ends and having a first outside diameter greater than said first inside diameter and less than said second inside diameter;
an upper end cap secured to said filter element first end and mounted to said housing upper section to fix said filter element in said housing lower section, said upper end cap including a plate extending radially outwardly from a second axial opening through which said first conduit extends when said cartridge is mounted to the base, said plate having a radially outer periphery adjacent said second side wall first end and spaced from said second side wall to define a fluid flow area; and
a lower end cap enclosing said filter element second end.

12. The filter cartridge of claim 11, wherein said fluid flow area has a radial dimension between 0.050 and 0.3 inches.

13. The filter cartridge of claim 11, wherein said first outer diameter is between 0.070 and 0.20 inches smaller than said second inside diameter.

14. The filter cartridge of claim 11, wherein said cartridge defines a flow path from said housing upper section, radially outwardly to said flow area and axially along said filter element and radially inwardly through said filter element.

15. The filter cartridge of claim 11, wherein said upper end cap includes radially projecting, angularly spaced ribs configured to maintain said fluid flow area between said housing lower section second inside diameter and said plate radially outer periphery.

16. The filter cartridge of claim 11, wherein said upper end cap comprises a lip axially projecting from said plate into said housing upper section, said lip defining a plurality of radial fluid flow passages communicating with said fluid flow area.

17. The filter cartridge of claim 11, wherein said filter element is a folded paper element having a pleat density at said first outside diameter of between 8 and 11 pleats per inch.

18. The filter cartridge of claim 11, wherein said filter element is a folded paper element comprising a series of pleats, each said pleat extending between said first outside diameter and an inside diameter.

19. The filter cartridge of claim 18, wherein said filter element has a pleat density at said inside diameter of between 15 and 21 pleats per inch.
